(19) United States
(12) Patent Application Publication
(10) Pub. No.: US 2006/0198494 A1
(43) Pub. Date: Sep. 7, 2006

(54) Three-dimensional structure analyzing system

(76) Inventors: Keiichi Tanaka, Chiba-shi (JP); Akikazu Odawara, Chiba-shi (JP)

Correspondence Address: BRUCE L. ADAMS, ESQ.;SUITE 1231, 17 BATTERY PLACE, NEW YORK, NY, 10004, US

(21) Appl. No.: 11/362,608

(22) Filed: Feb. 27, 2006

(30) Foreign Application Priority Data
Mar. 2, 2005 (JP) 2005-056842

(51) Int. Cl. G01N 23/223; G01T 1/36

(52) U.S. Cl. 378/45

(57) ABSTRACT

A three-dimensional structure analyzing system, which improves the energy resolution significantly, achieves low energy analysis, and allows the composition of a sample surface to be known with high accuracy. The three-dimensional structure analyzing system includes: an ion gun for irradiating at least a part of a sample with an ion beam thereby to machine the sample three-dimensionally; an electron gun for irradiating the sample three-dimensionally machined by the ion beam with electrons; an X-ray detector for detecting X-rays from the sample irradiated with electrons; and a composition analysis device for making a composition analysis of the sample based on a result of the detection by the X-ray detector. The X-ray detector is an energy dispersive superconducting X-ray detector.

### BACKGROUND OF THE INVENTION

1. Field of the Invention

The present invention relates to a three-dimensional structure analyzing system having an ion gun for irradiating at least a part of a sample with an ion beam thereby to machine the sample three-dimensionally and an electron gun for irradiating the three-dimensionally machined sample with electrons.

2. Background Art

Conventionally, there has been examined the possibility of a double beam system having an ion gun for irradiating a part of a sample with an ion beam thereby to machine the sample three-dimensionally and an electron gun for observing the three-dimensional sample machined by an ion beam. In addition, for elemental analysis of a section (processed section) of a sample machined by an ion beam, an X-ray detector, for which a silicon detector is utilized, has been used.

In JP-A-2002-151934 is proposed a technique concerning a vacuum system including: a focused ion beam optical system; an electron optical system; a manipulator; and a manipulator control device for driving the a manipulator independently of a wafer sample stage, wherein a small sample piece including a desired region of a sample is separated by charged particle beam machining, and the separated small sample piece is picked out using the manipulator.

However, the energy resolution of an X-ray detector, for which a silicon detector is utilized, is 130 eV or larger, and therefore it is impossible to make a composition analysis in a low-energy region (e.g. 5 kV or lower). The reason for this is as follows. That is, K-line coming from light elements, and L-line and M-line coming from heavy elements are mixed in a low-energy region, and it is required to make the energy resolution of an X-ray detector at least 30 eV or smaller for the purpose of achieving the separation of those peaks. In the past, the energy resolution of an X-ray detector has not been able to be made 130 eV or smaller, and thus it has been impossible to separate K-line (L2′ (K)) and L-line (L1′ (L)) mixed in a low-energy region (see FIG. 6). Hence, it has been required to analyze both light and heavy elements with K-line (L1′ (K), (L2′ (K)). However, to generate K-line of heavy elements, the acceleration voltage of an electron beam has to be raised to 10 kV or higher.

As described above, there has been the following problem in the past: the acceleration voltage of an electron gun has to be made 10 kV or larger for the purpose of making an elemental analysis on a sample section resulting from machining of the sample by an ion beam, and thus the energy of accelerated electrons damages a part of the sample, on which the electrons impinge.

Moreover, in the case where the sample is an insulator or organic film, when the acceleration voltage of an electron beam is 10 kV or larger, the sample is charged up, which makes an image blurred. To avoid the charge-up problem, it is required to coat a face targeted for analysis with a conductive film. Specifically, the following steps are needed: machining the sample by an ion beam; coating a section of the insulating film, machining the resultant sample by an ion beam to analyze an underlying layer; coating a newly exposed section with a conductive film; then making an analysis; etc. This is very time-consuming. Further, the following problem arises because the sample is covered with a coating film. That is, a signal coming from the conductive film is concurrently produced at the time of the composition analysis, which makes the analysis more complicated.

### SUMMARY OF THE INVENTION

Therefore, it is an object of the invention to provide a three-dimensional structure analyzing system which improves the energy resolution significantly, achieves low energy analysis, and allows the composition of a sample surface to be known with high accuracy.

A three-dimensional structure analyzing system according to some aspects of the invention includes: an ion gun for irradiating at least a part of a sample with an ion beam thereby to machine the sample three-dimensionally; an electron gun for irradiating the sample three-dimensionally machined by the ion beam with electrons; an X-ray detector for detecting X-rays from the sample irradiated with electrons; and a composition analysis device for making a composition analysis of the sample based on a result of the detection by the X-ray detector, wherein the X-ray detector is an energy dispersive superconducting X-ray detector.

With the three-dimensional structure analyzing system, the sample three-dimensionally machined by the ion gun is irradiated with electrons from the electron gun. As a result, X-rays generated in the sample are detected by the X-ray detector. The X-ray detector is one of detectors, for which superconduction is utilized. Such X-ray detectors include STJ (Superconducting Tunneling Junction) type ones and calorie meter type ones. In the STJ type X-ray detector, cooper pairs are destroyed by the absorption of X-rays thereby to generate quasi-particles, and then the number of the quasi-particle is counted. In the calorie meter type X-ray detector, a large change in resistance arising when the condition changes from normal conduction to superconduction is utilized as a thermometer. The STJ type X-ray detector generates a larger amount of signals when absorbing photons having a certain energy in comparison to a conventional semiconductor detector and as such, the energy resolution can be improved significantly in comparison to the conventional case. Therefore, the acceleration voltage of electrons emitted from the electron gun can be reduced significantly in comparison to the conventional case. As for the calorie meter type X-ray detector, when it absorbs photons having a certain energy, a small increase in temperature is caused inside, and a large change in resistance can be obtained under the condition where the operation point is kept in the transition edge of the superconduction. The calorie meter under the condition of a constant voltage can produce a large current signal in response to a small temperature change. Also, since the calorie meter can reduce noise by lowering the operation temperature, the superconducting transition temperature is made low as far as possible. As a result, S/N ratio (Signal to Noise Ratio) can be made larger, and the energy resolution can be improved significantly in comparison to a conventional case. Therefore, the acceleration voltage of electrons emitted from the electron gun can be reduced significantly in comparison to the conventional case. Hence, when the acceleration voltage is lowered, the characteristic X-ray generated region is limited to an area near the surface of a sample section and, composition analysis, whose target is further limited to a sample surface in comparison to the conventional case, is enabled. Further, when an energy dispersive X-ray detector is used as the superconducting X-ray detector, two or more different X-rays can be detected over a wide energy band at a time. Here, to machine three-dimensionally means not to machine a sample in two-dimensional shape, but to excavate a given location in a sample surface into an uneven shape. By machining a sample three-dimensionally, not only the composition of a surface of a sample, but also the composition of the inside thereof can be detect and analyzed.

It is preferable that in the above three-dimensional structure analyzing system, an acceleration voltage of the electrons irradiated from the electron gun is 0.1 to 1.5 kV. With the three-dimensional structure analyzing system, when the acceleration voltage is made 0.1 to 5 kV, almost all the elements can be analyzed, because a light element can excite K-line, and a heavy element can excite L-line and M-line. Further, the energy of an electron beam within such energy region is adequately low, and therefore damage to the sample can be held down adequately. Especially, this energy region allows the characteristic X-ray generated region to be restricted to several tens to several hundreds nanometers, and thus a composition analysis near a sample surface can be made.

It is preferable that in the three-dimensional structure analyzing system, an energy resolution of the superconducting X-ray detector is 30 eV or smaller.

With the three-dimensional structure analyzing system, by making the energy resolution as described above, even when the acceleration voltage of electrons irradiated from the electron gun is held down to 5 kV or smaller, al the composition analyses can be made. For example, Si (silicon) and W (tungsten), which are important materials for semiconductors, can be analyzed with K-line and M-line.

It is preferable that in the three-dimensional structure analyzing system, the sample at least contains an insulator selected from the group of a ceramic, an organic film, an insulating film used for a semiconductor and the like.

With the three-dimensional structure analyzing system, by holding down the acceleration voltage of electrons irradiated from the electron gun is held down to 5 kV or smaller, charging-up of the insulator can be reduced. Thus, immediately after the machining by an ion beam, a composition analysis can be made without the need for some operation. When the acceleration voltage of electrons is 10 kV or larger as in conventional cases, to make a composition analysis of the processed section after machining the insulator, it is necessary to coat the resultant sample with a conductive film to prevent charging-up. For this coating, various processes as described above are required. However, according to the invention, the need for coating of the conductive film is eliminated. Further, various processes involved in the coating can be made unnecessary and therefore a large number of workload can be reduced significantly.

Further, it is preferable that the three-dimensional structure analyzing system additionally includes at least one superconducting X-ray detector identical to the above-described superconducting X-ray detector.

With the three-dimensional structure analyzing system, when two or more superconducting X-ray detectors identical to the above-described ones are provided, the X-ray detection area can be made the X-ray detection area in the case of one detector being provided multiplied by the number of the provided detectors, and the X-ray counting rate can be increased. Here, the counting rate is the number of X-rays that can be counted per second.

Also, it is preferable that in the three-dimensional structure analyzing system, the superconducting X-ray detector is a calorie meter type superconducting X-ray detector, and the analyzing system includes at least six superconducting X-ray detectors identical to the above-described superconducting X-ray detectors in total.

With the three-dimensional structure analyzing system, the counting rate equivalent to that of a semiconductor detector, which is of high-resolution type in the existing circumstances in the art, can be achieved. In addition, the superconducting X-ray detector is ten times or higher the energy resolution of the semiconductor detector and as such, when measurements are made for the same time, it achieves ten times or more the detection sensitivity of the semiconductor detector. Specifically, the pulse time constant of a calorie meter is about 100 μs in the existing circumstances in the art, and the counting rate that can be counted by one detector is 500 cps. When six detectors are arranged, the total counting rate is 3000 cps, which is equivalent to the counting rate of a high-resolution type semiconductor detector.

According to the invention, the energy resolution can be improved significantly, and low energy analysis can be achieved. Therefore, the composition of a sample surface can be known with high accuracy.

### BRIEF DESCRIPTION OF THE DRAWINGS

FIG. 1 is a sectional view of an important part showing a configuration of a three-dimensional structure analyzing system according to an embodiment of the invention;

FIG. 2 is a schematic sectional view showing the principle of operation of the three-dimensional structure analyzing system;

FIG. 3 is a graph showing the energy resolution of an X-ray detector in the embodiment and a conventional one;

FIG. 4 is a graph showing the relation of temperatures and resistances on a sample targeted for measurement;

FIG. 5 is an illustration showing the outline of a configuration of a superconducting X-ray detector shown in FIG. 1; and

FIG. 6 is a graph showing the energy resolution of a conventional X-ray detector.

### EMBODIMENT

A three-dimensional structure analyzing system according to an embodiment of the invention will be described below in reference to the drawings.

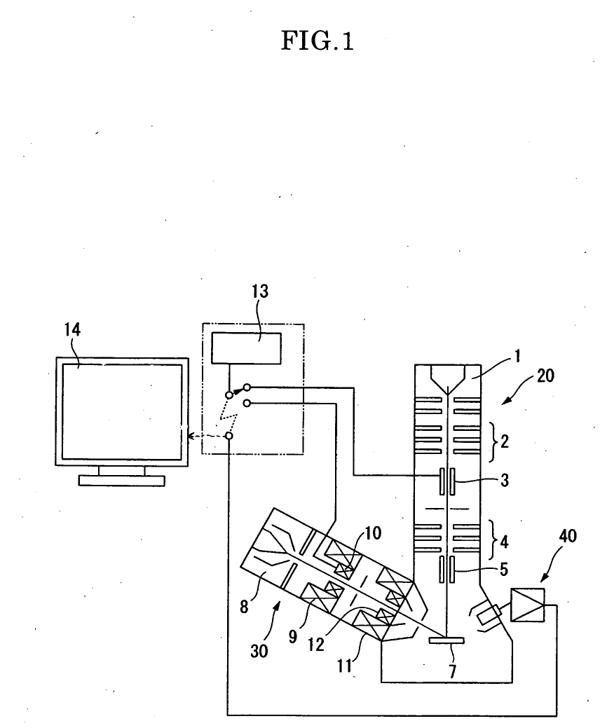

FIG. 1 is a sectional view of an important part showing a configuration of the three-dimensional structure analyzing system according to the embodiment. As shown in FIG. 1, the three-dimensional structure analyzing system has: an ion irradiating device 20 for irradiating at least a part of a sample 7 with an ion beam thereby to machine the sample 7 three-dimensionally; an electron irradiating device 30 for irradiating the sample 7 three-dimensionally machined by an ion beam with electrons; a superconducting X-ray detector 40 for X-ray detection; and a computer as a composition analysis device for analyzing the constituents of the sample 7.

The ion irradiating device 20 includes: an ion source 1; a condenser lens 2; a beam blanking 3; an objective 4; and an X-Y deflection electrode 5. The sample 7 is irradiated with an ion beam narrowed down by the ion-irradiating device 20, whereby the sample 7 is machined three-dimensionally.

On the other hand, the electron-irradiating device 30 includes: an electron gun 8, a condenser lens 9; a beam blanking 10; an objective 11; and an X-Y deflection electrode 12. When the sample 7 is irradiated with electrons by the electron-irradiating device 30, X-rays are produced form the sample 7.

The three-dimensional structure analyzing system in the embodiment uses a beam switching unit 13 to switch between an ion-irradiation system and an electron-irradiation system. It is distinguished by controlling in this way whether the secondary electrons emitted from the sample 7 come from the ion beam excitation or electron beam excitation, whereby a scanned image can be displayed. The result of detection by a superconducting X-ray detection device 40 is displayed on an image display device 14 of the computer for control.

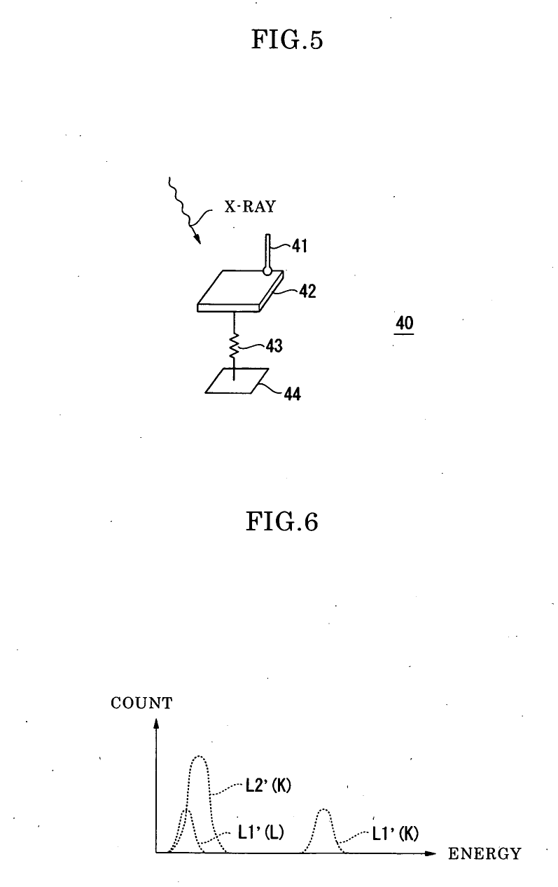

The configuration of the superconducting X-ray detection device 40 will be outlined in reference to FIG. 5. While the superconducting X-ray detection device shown here is of calorie-meter type, it may be of STJ type. In the following description, it is assumed to be a calorie-meter type device. As shown in FIG. 5, the superconducting X-ray detector 40 includes: an absorber 42 for absorbing X rays; a thermometer 41 for detecting a small change in temperature caused in the absorber 42; and a thermal link 43 for releasing heat generated in the absorber 42 and thermometer 41 to a hot bath 44. The thermometer 41 is in its constant potential state, the temperature of the thermometer 41 when the Joule heat generated in the thermometer 41 and the heat released from the thermometer 41 to the hot bath 44 are thermally balanced with each other is kept in the range of the transition edge (see Range A in FIG. 4). Their thermal relation is given by the following expression (1).
P=G(T−T_{bath}) (1)
where P represents Joule heat generated in the thermometer; G represents the thermal conductivity of the thermal link; T represents a transition temperature; and T_{bath} represents the temperature of the hot bath. In the case where the operation point is kept in the range of the transition edge, when the temperature of the thermometer 41 under the condition of a constant voltage rises with the absorption of X-rays, the resistance value increases according to a transition curve. When the resistance of the thermometer under the condition of the constant voltage changes, a current pulse 61 is generated. The current pulse 61 is given by the following expression (2).
δ1=δ(V/R)=−IδR/R=−IαδT/T (2),
where α is a nondimensional parameter showing the steepness of the superconducting transition, which can offer a value several tens-fold value in comparison to a conventionally used semiconductor calorie meter. Therefore, a calorie meter in which a superconductor is used offers a larger pulse signal with respect to the same temperature change δT. Further, forcing the superconducting transition temperature to reach the absolute zero point can lower the noise of the thermometer itself. In this way, S/N ratio can be made larger and as such, the energy resolution can be improved significantly in comparison to that achieved in the art. Therefore, the acceleration voltage of electrons emitted from the electron gun 8 can be reduced significantly in comparison to that used conventionally.

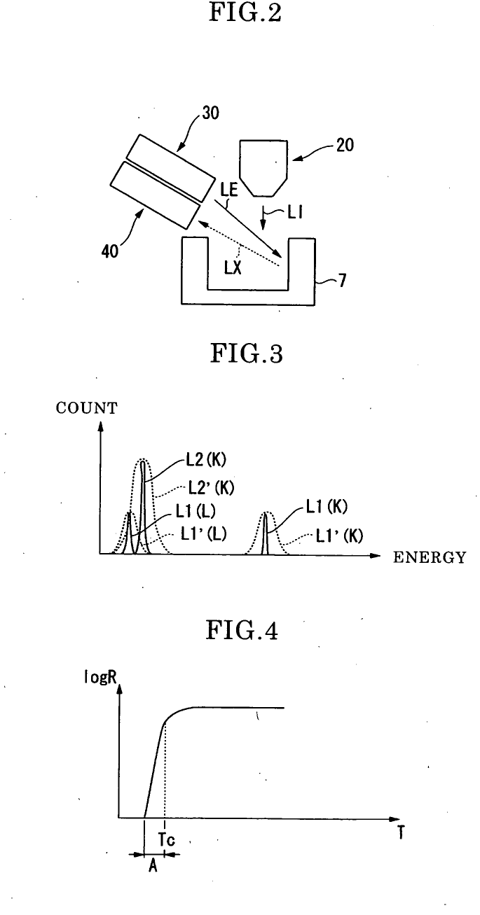

Now, the operation of the three-dimensional structure analyzing system having a configuration as described above will be described in reference to FIG. 2. First, a process of irradiating a give region of the sample 7 with an ion beam LI thereby to excavate the sample 7 to a given depth and expose the inside of the sample is executed (three-dimensional machining). Next, the sample 7 is irradiated with an electron beam LE by the electron-irradiating device 30, thereby making the irradiated sample 7 radiate X-rays. At this process, the acceleration voltage of the electron beam can be made lower in comparison to that used conventionally. Therefore, a characteristic X-ray generated region is limited to an area near the surface of a section of the sample 7 accordingly, and composition analysis, whose target is further limited to a sample surface in comparison to a conventional case, is enabled. The generated X-rays LX are detected by the superconducting X-ray detector 40 to perform composition analysis of the sample 7. Using the superconducting X-ray detector 40 as described above can improve the energy resolution significantly. Therefore, it is possible to separate K-line (L2(K)) and L-line (L1 (L)), which are mixed in a low-energy region, unlike a conventional case (see FIG. 3).

As described above, with the three-dimensional structure analyzing system in the embodiment, the energy resolution can be improved significantly, and low energy analysis can be achieved. Therefore, the composition of a sample surface can be known with high accuracy.

While the information on the invention has been described above based on the embodiment, it is obvious that the information on the invention is not limited to only the embodiment. For example, the three-dimensional structure analyzing system may further include a secondary electron detector for detecting secondary electrons generated by irradiating a sample with an electron beam or ion beam. Further, it may further include a secondary ion detector for detecting ions coming from a sample.

The acceleration voltage of 0.1 kV to 5 kV can hold down the damage to a sample adequately. Especially, the energy region can suppress the characteristic X-ray generated region within a range of several tens to several hundreds nanometers and as such, a composition analysis of a nearly surface region of a sample can be made, and the damage to the sample by an electron beam can be suppressed. In this respect, the analysis by the three-dimensional structure analyzing system is preferable to a conventional characteristic X-ray analysis. Especially, it is useful from the view point of reduction in sample damage that the three-dimensional structure analyzing system is applied to analyses of an insulator and an organic film.

It is preferable that even in the case where the acceleration voltage of electrons emitted from the electron gun is held down at or under 5 kV, analyses on all the constituents can be made, as long as the energy resolution of the superconducting X-ray detector is 30 eV or smaller.

With the three-dimensional structure machining system according to the invention, even when the sample at least contains an insulator such as a ceramic, an organic film, or an insulating film used for a semiconductor, the operation to ensure electrical conductivity immediately after the ion beam machining is not required, and composition analysis can be made.

In addition, when two or more superconducting X-ray detectors identical to the above-described ones are provided, the X-ray detection area can be made the X-ray detection area in the case of one detector being provided multiplied by the number of the provided detectors, and the X-ray counting rate can be increased. In this respect, the three-dimensional structure machining system is preferable.

Further, in the case where the superconducting X-ray detector is of calorie meter type, it is preferable that the three-dimensional structure machining system includes at least 6 superconducting X-ray detectors identical to the above-described superconducting X-ray detector. When the system is so arranged, the counting rate equivalent to that of a semiconductor detector, which is of high resolution type in the existing circumstances in the art, can be achieved. In addition, the superconducting X-ray detector is ten times or higher the energy resolution of the semiconductor detector and as such, when measurements are made for the same time, it achieves ten times or more the detection sensitivity of the semiconductor detector.

What is claimed is:

1. A three-dimensional structure analyzing system, comprising:
an ion gun for irradiating at least a part of a sample with an ion beam thereby to machine the sample three-dimensionally;
an electron gun for irradiating the sample three-dimensionally machined by the ion beam with electrons;
an X-ray detector for detecting X-rays from the sample irradiated with electrons; and
a composition analysis device for making a composition analysis of the sample based on a result of the detection by the X-ray detector,
wherein the X-ray detector is an energy dispersive superconducting X-ray detector.

2. The three-dimensional structure analyzing system of claim 1, wherein an acceleration voltage of the electrons irradiated from the electron gun is 0.1 to 5 kV.

3. The three-dimensional structure analyzing system of claim 2, wherein an energy resolution of the superconducting X-ray detector is 30 eV or smaller.

4. The three-dimensional structure analyzing system of claim 1, wherein the sample at least contains an insulator selected from the group of a ceramic, an organic film, an insulating film used for a semiconductor and the like.

5. The three-dimensional structure analyzing system of claim 1, additionally comprising a plurality of the superconducting X-ray detectors.

6. The three-dimensional structure analyzing system of claim 1, wherein the superconducting X-ray detector is a calorie meter type superconducting X-ray detector, and
the analyzing system comprises at least six of the superconducting X-ray detectors.
